(19) United States
(12) Patent Application Publication
(10) Pub. No.: US 2019/0281816 A1
(43) Pub. Date: Sep. 19, 2019

(54) Formulation

(71) Applicants: University of Leeds, Leeds (GB); Asymptote Ltd., Cambridge (GB)

(72) Inventors: Benjamin John Murray, Leeds (GB); Thomas Francis Whale, Leeds (GB); Theodore William Wilson, Leeds (GB); George John Morris, Cambridgeshire (GB)

(21) Appl. No.: 16/300,618

(22) PCT Filed: May 12, 2017
(86) PCT No.: PCT/GB2017/051324

§ 371 Date: Nov. 12, 2018

(30) Foreign Application Priority Data
May 12, 2016 (GB) 1608356.0

(51) Int. Cl. A01N 1/02

(52) U.S. Cl. CPC A01N 1/0221

(57) ABSTRACT

The present invention relates to a formulation for promoting non-spontaneous formation (nucleation) of ice during freeze processing of a water-containing quantity of a biological entity which comprises a framework silicate mineral capable of acting as an ice nucleant and an ammonium salt.

### FORMULATION

The present invention relates to a formulation for promoting non-spontaneous formation (nucleation) of ice during freeze processing of a water-containing quantity of a biological entity and to its use in freeze processing of a water-containing quantity of a biological entity.

There are two related processes for the preservation of biological material. In cryopreservation, the biological material is frozen and stored in the frozen state. In freeze drying (lyophilisation), water is removed from the frozen biological sample which is then stored in the dried state.

Cryopreservation is widely employed to maintain long term viability of biological samples for use in medicine, biotechnology and veterinary science. In order to obtain high viability upon thawing it is necessary to add protective compounds (known as cryoprotective additives or cryoprotectants) and cool samples at a controlled rate. With many cell types, it is necessary to induce ice formation by controlled nucleation rather than to allow spontaneous ice nucleation at an uncontrolled supersaturation.

Samples for cryopreservation are generally placed in specialist cryocontainers such as the following:
Straws which are thin walled tubes of 2 to 4 mm diameter and length up to 140 mm with a capacity of 0.2 ml to 0.5 ml;
Cryovials which are wide short tubes of about 12.5 mm diameter and a capacity of 0.5 ml to 5.0 ml;
Flexible bags with a capacity of 5 ml to 1000 ml for the cryopreservation of larger volumes; and
Microtitre plates, matrix tubes and other SBS formats employed in robotics and high throughput screening.

A range of equipment is available to freeze straws and cryovials at a controlled rate. These may use liquid nitrogen as a cryogen or be cooled by mechanical refrigeration. Additionally a number of passive cooling devices exist. Some of these devices allow the controlled nucleation of ice within samples which may be carried out manually or automatically.

Following freezing at a controlled rate, samples are held frozen at low temperature (typically the temperature of liquid nitrogen (−196° C.)). At this temperature, the viability of a cell is independent of the period of storage if it survived cooling. When required for use, the samples are thawed rapidly (generally in a water bath maintained at 37° C.) and the cryoprotectant is removed.

Freeze drying (lyophilization) is used extensively in biotechnology, medicine and veterinary science for the long term stabilisation of cells, vaccines, proteins and other bioactive compounds. Freeze drying is also used to generate structured materials such as scaffolds and matrices for application in regenerative medicine and in the production of novel ceramics. In the freeze drying process, aqueous samples are placed in specialist containers (typically glass vials) and frozen on a cooled shelf in a freeze drier. Following freezing, the local gas pressure is reduced and ice within the frozen sample sublimates. Following removal of water from the sample, the vial is warmed under vacuum and sealed. The sample may be distributed at ambient temperature and is reconstituted by adding water.

A number of ice nucleants (sometimes referred to as ice nucleators, ice nucleating catalysts, ice nucleating particles or ice nuclei) have been examined for controlled ice nucleation of cryopreservation samples. These ice nucleants promote a phenomenon referred to as heterogeneous nucleation. Examples include crystals of silver iodide, the bacterium Pseudomonas syringae, crystals of cholesterol and minerals of the framework silicate class (see for example WO-A-2014/091216). The ice nucleants are added to the sample which is then cooled. When a sufficient level of supercooling is attained within the sample, ice nucleation occurs. A previous study by Zimmerman et al J. Geophys. Res. Atmos., 2008, 113, D23204 which investigated ice nucleation by feldspars had shown them to be ineffective at nucleating ice at sufficiently warm temperatures for freeze processing of a water-containing quantity of a biological entity. Nedava et al SELSKOKHOZYAISTVENNAYA BIOLOGIYA (Agricultural Biology), 1992, No. 4, 20-24 described adding finely divided silica to suspensions of ram sperm with the aim of improving outcomes during cryobiological procedures. This was done in an attempt to stabilise the membranes of the sperm cells rather than induce nucleation.

Generally speaking the perceived toxic impact of ammonium salts on has been strongly dissuasive to their use in cryopreservation. Nevertheless H T Meryman (1968) Modified Model for the Mechanism of Freezing Injury in Erythrocytes. Nature 218, 333-336 demonstrated that red blood cells frozen in the presence of high concentrations (2M, 3M and 4M) of ammonium acetate as a cryoprotectant had significantly reduced freezing injury compared with cells frozen in the presence of other cryoprotectants such as sodium salts. This was a physical phenomenon attributed to osmotic pressure gradients and is unrelated to nucleation. Meryman stated that ammonium chloride is useless as a protective agent.

With ice nucleants such as minerals of the framework silicate class, it is necesssary to add relatively large amounts (10 mg) to achieve ice nucleation at low levels (3° C.) of supercooling. This becomes limiting when processing small sample volumes such as those used during cryopreservation in multiwell plate formats where the volumes may be 50 μL to 200 μL (96 well multiwell plates) or 10 μL (384 well multiwell plates). Moreover it is observed even with ice nucleation close to the melting point that the viability and cell recovery of many cell types following cryopreservation can be disappointingly low. It is commonly observed immediately following freezing that the cell viability (as measured by a dye exclusion assay) is high (95%) but this may fall to less than 50% following incubation of the cells for 24 hours. A similar pattern may be observed with cell number density which may be reduced by 50% following incubation as cells lyse during post thaw culture. The resultant cell recovery (cell viability x cell number density) could be 25% of the original unfrozen control value. This loss of cell recovery may limit the usefulness of frozen and thawed samples in applications such as high throughput screening and regenerative medicine.

The paradigm in the atmospheric community is that the identity of any solute is unimportant for heterogeneous ice nucleation and that there is no effect other than the solute's colligative effect. For example, Zobrist et al J. Phys. Chem. A 2008, 112, 3965-3975 stated that heterogeneous ice nucleation temperatures for nonadecanol, amorphous silica, silver iodide and Arizona test dust suspended in various aqueous solutions can each be described by a single line, irrespective of the nature of the solute. Knopf et al Faraday Discuss., 2013, 165, 513 stated that when using a variety of ice nucleants suspended in various aqueous solutions, the immersion freezing temperatures and kinetics can be described solely by temperature and solution water activity. However, this is not always the case. Gobinathan et al Mat. Res. Bull., Vol 16, 1527-1533 reported that lead iodide nucleates ice at warmer temperatures in the presence of certain salts. Salem el al Atmos. Chem. Phys. 7, 3923-3931, 2007 exposed a clay mineral to ammonia gas and found that ‘processed’ clay (montmorillonite) was better at nucleating ice. Rieschel and Vali, Tellus, 27(4), 414 (1975) reported that nucleation temperatures generally decrease for materials in leaf litter when ammonium salts are added whereas nucleation temperatures generally increase for clay on addition of ammonium salts. Abbatt et al Science, 22 Sep. 2006: Vol. 313, Issue 5794, pp. 1770-1773 show that solid crystalline ammonium sulphate can nucleate ice below water saturation.

The present invention is based on the recognition that the presence of an ammonium salt leads to an unexpected enhancement in the efficacy of ice formation by a framework silicate mineral added to a water-containing product as an ice nucleant during (for example) freeze processing of a water-containing quantity of a biological entity.

Thus viewed from a first aspect the present invention provides a formulation for promoting non-spontaneous formation of ice during freeze processing of a water-containing quantity of a biological entity comprising:
a framework silicate mineral capable of acting as an ice nucleant; and an ammonium salt.

By promoting non-spontaneous formation of ice, the formulation advantageously provides a greater element of control over ice nucleation which then contributes to preserving the integrity of the biological entity. This may be useful in processes such as (for example) cryopreservation or freeze drying. The element of control may be exerted on the number and size of ice crystals and (for example) allow an increase in the number of ice crystals leading to smaller ice crystals.

By acting as an ice nucleant, the framework silicate mineral contributes to heterogeneous nucleation.

In a preferred embodiment, the framework silicate mineral is multi-elemental. The framework silicate mineral may have at least two (eg a pair of) elements selected from Group 1A or 2A (eg from K, Ca and Na). One or more of the elements selected from Group 1A or 2A may be ionically substitutional by ammonium ions.

The framework silicate mineral may be obtained by processing (eg refinement or concentration) of a mineral source (eg rock, gem or ore) by (for example) one or more physical (eg mechanical) processes such as crushing and gravitational, magnetic or electrical separation or by chemical processes. The framework silicate mineral may be a concentrate which is commercial grade or industrial grade. Framework silicates may also be synthesised.

The framework silicate mineral is generally characterised by the predominance of a certain crystal structure. There may be traces of other material present in the framework silicate mineral (eg trace minerals such as a clay or calcite or trace non-minerals) which may be endogenous to the mineral source.

Preferably the framework silicate mineral is selected from the group consisting of Feldspar, Silica (eg Quartz, Tridymite, Cristobalite, Chalcedony or Jasper), Nepheline, Petalite, Leucite, Sodalite, Cancrinite (eg Cancrinite-Vishnevite), Scapolite, Analcite and Zeolite.

In a preferred embodiment, the framework silicate mineral is a framework aluminosilicate.

In a preferred embodiment, the framework silicate mineral is a Silica (eg Quartz).

In a preferred embodiment, the framework silicate mineral is a Feldspar or Feldspathoid. In a particularly preferred embodiment, the framework silicate mineral is a Feldspar.

The Feldspar may be (or consist essentially of) a ternary solid solution of CaAl₂Si₂O₈, NaAlSi₃O₈ and KAlSi₃O₈.

In a particularly preferred embodiment, the framework silicate mineral is a Feldspar with a predominance of NaAlSi₃O₈ and KAlSi₃O₈ (ie a predominance of Na and K cations-an alkali Feldspar). The alkali Feldspar may be selected from the group consisting of orthoclase, sanidine, microcline and anorthoclase.

In a more preferred embodiment, the framework silicate mineral is a Feldspar with a predominance of KAlSi₃O₈ (ie a predominance of K cations-potassium Feldspar or K-spar). Preferred is microcline.

In a particularly preferred embodiment, the framework silicate mineral is a Feldspar with a predominance of CaAl₂Si₂O₈ and NaAlSi₃O₈ (ie a predominance of Ca and Na cations-a plagioclase Feldspar). The plagioclase Feldspar may be selected from the group consisting of albite, oligoclase, andesine, labradorite, bytownite and anorthite.

In a more preferred embodiment, the framework silicate mineral is a Feldspar with a predominance of NaAlSi₃O₈ (ie a predominance of Na cations).

The framework silicate mineral may be particulate. The average particle size of the framework silicate mineral may be submicron or in the range 1 to 5 μm. The framework silicate mineral may be nanoparticulate. The framework silicate mineral may be a powder.

The framework silicate mineral may be in a discrete form. The discrete form may be an optionally membrane-bound pellet, bead, tablet or fragment or a powder. Beads typically have a millimetre dimension.

Typically the formulation is an aqueous formulation. The formulation may be a solution, suspension, dispersion, emulsion or colloid.

Preferably the formulation is biologically (eg physiologically) tolerable. Particularly preferably the formulation is cellularly tolerable.

The formulation may be an intracellular, intercellular or extracellular fluid mimetic.

The framework silicate mineral may be present in the formulation in an amount in excess of 3×10⁻⁶ cm² of surface area per aliquot of water-containing quantity.

Preferably the framework silicate mineral is present in the formulation in an amount in the range 1×10⁻⁵ to 400 cm² of surface area per aliquot, particularly preferably an amount in the range 1×10⁻³ to 400 cm² of surface area per aliquot, more preferably an amount in the range 1 to 400 cm² per aliquot.

Preferably the formulation further comprise one or more cryoprotectants.

The one or more cryoprotectants may be selected from the group consisting of dimethylsuphoxide, glycerol, ethylene glycol, propylene glycol, a sugar (such as trehalose, sucrose, raffinose or glucose), a polymer (such as polyvinylprollidone or polypropylene glycol) or dextran.

A preferred cryoprotectant is characterised by the presence of a plurality of hydroxyl groups (eg a sugar or polyalcohol).

Preferably the ammonium salt is ammonium chloride, ammonium sulphate, ammonium iodide, ammonium acetate or ammonium hydroxide.

Particularly preferably the ammonium salt is ammonium chloride.

Preferably the concentration of the ammonium salt is in the range 1×10⁻⁵ to 10 M, particularly preferably in the range 10 to 350 mM, more preferably in the range 50 to 300 mM, yet more preferably in the range 100 to 200 mM (eg about 150 mM).

The formulation may further comprise mineral additives or non-mineral additives added in trace amounts. The mineral additive may be a framework silicate mineral as hereinbefore defined.

By promoting non-spontaneous formation of ice, the formulation of the present invention causes the water-containing quantity to freeze at a reduced supercooling. In a preferred embodiment, the formulation causes the water-containing quantity to freeze at a supercooling of 10° C. or less, preferably of 8° C. or less, more preferably of 6° C. or less.

Supercooling (also referred to as undercooling) is the temperature of a liquid persisting below the melting point. For example at −5° C., water would be supercooled by 5° C. whilst a 10% glycerol solution (melting point −2° C.) would be supercooled by 3° C.

Viewed from a further aspect the present invention provides the use of a formulation as hereinefore defined in freezing processing a water-containing quantity of a biological entity in a vessel.

The water-containing quantity may be a solution, suspension, dispersion, emulsion or colloid of the biological entity.

The biological entity is typically one which has a tendency to lose integrity over time and/or in the presence of environmental stimuli (eg a physical stimulus such as heat or a chemical stimulus such as an enzyme).

The biological entity may derive from a plant or animal (eg from a mammal such as a human).

The biological entity may be a natural foodstuff such as fruit, nuts, herbs or seeds (eg coffee).

Preferably the biological entity is a cell or aggregate of cells (eg a microorganism, microbe, uni-cellular organism, tissue, organ or multi-cellular organism).

By way of example, the cell may be a stem cell, oocyte cell, sperm cell or embryonic cell.

By way of example, the tissue may be skin, tumour, embryonic, testicular or ovarian.

The biological entity may be a protein, enzyme, vaccine, bacterium, virus, protist, protozoan, parasite, spore, seed or fungus.

The vessel may be a sample container or a freezing container such as (for example) a straw, cryovial, bag, microtitre plate or mixing chamber. The water-containing quantity of the biological entity may be added to the formulation. For example, a cell suspension may be added to the formulation or cells may be centrifuged and resuspended in the formulation.

During freeze processing, the vessel may be floated on or immersed in a cryogen (typically liquid nitrogen). Alternatively freeze processing may be carried out by mechanical refrigeration (eg in a freeze drier or heat exchanger) or by a controlled rate freezer which may be liquid nitrogen-based.

Freeze processing may proceed to a temperature below −130° C., preferably to a temperature below −150° C., particularly preferably to a temperature of about −196° C.

Freeze processing may be carried out incrementally (eg stepwise or continuously).

Typically freeze processing is carried out continuously at a rate in the range 1 to 2° C./min.

Freeze processing may comprise: dehydrating the water-containing quantity of the biological entity. The step of deydrating may be carried out by sublimation. Sublimation may be induced by applying a reduction in pressure (eg a partial vacuum) to the vessel.

Embodiments of the invention will now be described by way of example only with reference to the following Examples and Figures in which:

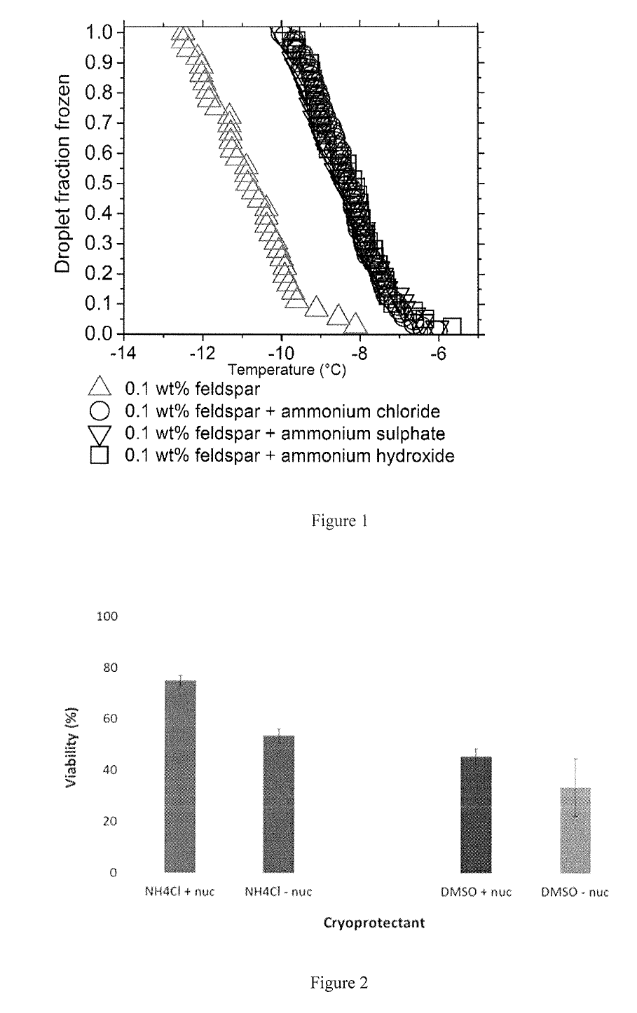

FIG. 1 shows the temperature dependence of the droplet fraction for various ice nucleants tested in Example 1;

FIG. 2 shows cell viability measured in Example 2; and

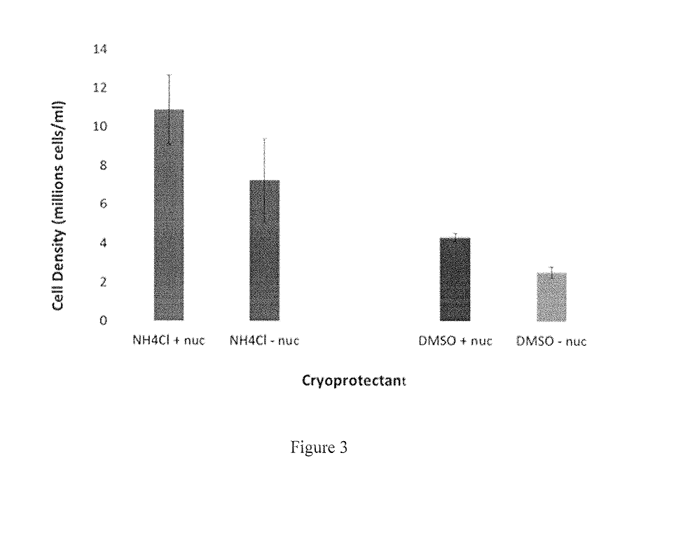

FIG. 3 shows cell density measured in Example 2.

### EXAMPLE 1 ENHANCEMENT OF ICE NULEATION BY FELDSPAR IN THE PRESENCE OF AMMONIUM Salts

Experiments were conducted on μL-nucleation in an immersed particles instrument which is described in detail by Whale et al (2015) Technique for Quantifying Heterogeneous Ice Nucleation in Microlitre Supercooled Water Droplets. Atmos. Meas. Tech. 8, 2437-2447. This instrument measures the freezing temperature of approximately 50 droplets of 1 μL volume. In these experiments, a 0.1 wt % suspension of a framework silicate (IceStart™ (Asymptote Ltd)) was frozen in pure water and in 0.07 M solutions of ammonium chloride, sulphate and hydroxide. The results are shown in FIG. 1 from which it can be seen that the ammonium compounds lowered the supercooling by approximately 2.5° C.

### EXAMPLE 2 VIABILITY AND CELL NUMBER FOLLOWING CRYOPRESERVATION OF ENCAPSULATED HEPATOCYTES BY THE FORMULATION OF THE INVENTION

### Cell Culture and Encapsulation

HepG2 cells were cultured in monolayer. At reaching 80-90% confluence, cells were passaged. An aqueous solution containing 2% alginate (Manugel, FMC bio-polymers) was mixed at a ratio of 1:1 in a culture medium containing 4 million cells/ml. This mixture was passed through a Genialab Jetcutter encapsulation system to produce spherical droplets of radius 500 μm which were polymerized in a 0.204M CaCl₂ solution. This produced spheroids with individual cells distributed internally. The spheroids were added to a warmed culture of modified alpha-MEM, supplemented with 50 U/ml penicillin, 50 μg/ml streptomycin (Invitrogen plc), 1M 0.5% CaCl₂ (v/v) and 10% human blood plasma in T175 flasks at a spheroid:medium ratio of 1:32. These were cultured in a humidified incubator at 37° C., 5% CO₂. 100% medium changes were carried out every 2-3 days.

### Cryopreservation

Cryopreservation was carried out by cooling the spheroids to 4° C. and mixing in a 1:1 ratio with precooled solutions of:
24% dimethyl sulphoxide (DMSO) in a Viaspan solution containing 0.2 wt % feldspar as a nucleating agent (DMSO+Nuc)
24% DMSO in a Viaspan solution (v/v) (DMSO−Nuc)
24% DMSO in a 300 mM ammonium chloride (v/v) containing 0.2 wt % feldspar as a nucleating agent (NH₄Cl+Nuc)
24% DMSO in a 300 mM ammonium chloride (v/v) (NH₄Cl−Nuc)

The solutions were allowed to equilibrate for 5 minutes. After that, 1 ml supernatant was added to 5×1.8 ml cryovials per condition which were then cooled from 4° C. to −100° C. at 0.3° C./min in an EF600 controlled rate freezer. Upon completion of the cooling run, the cryovials were transferred to liquid nitrogen storage.

### Warming Protocol

Samples were removed from liquid nitrogen storage and thawed in a 37° C. water bath until the last ice crystal had just melted. This took 330 seconds. The cryoprotectant was washed out in a stepwise manner using culture medium chilled to 4° C. After the cryoprotectant had been washed out, culture medium warmed to 37° C. was added and the ELS placed in culture in a humidified incubator at 37° C., 5% CO₂.

### Post-Thaw Functional Assessments

### Viability

At designated timepoints, ELS were removed from culture and stained with 20 μl propidium iodine solution (PI, 1 mg/ml, Sigma) and 10 μl fluorescein diacetate solution (FDA, 1 mg/ml, Sigma) to view under a fluorescent microscope. As PI stains the nucleus of cells with a non-functional membrane, it is an indicator of dead cells. FDA stains metabolically active cells. By comparing the intensities of PI and FDA emissions using a calibrated macro, viability can be determined. The results are shown in FIG. 2.

### Cell Counts

Total cell number was determined using a nucleocounter system. The ELS were liberated from alginate using a 16 mM EDTA solution (Applichem) before being washed in PBS and disaggregated. All cells were lysed in solution and the nucleolus stained with PI. This solution was drawn into a nucleocassette and stained nuclei were counted. As HepG2 cells are mononuclear, this could be converted to a cell density in the ELS. The results are shown in FIG. 3.

1. A formulation for promoting non-spontaneous formation of ice during freeze processing of a water-containing quantity of a biological entity comprising:
a framework silicate mineral capable of acting as an ice nucleant; and
an ammonium salt.

2. A formulation according to claim 1 wherein the framework silicate mineral is multi-elemental.

3. A formulation according to claim 2 wherein the framework silicate mineral is a framework aluminosilicate.

4. A formulation according to claim 2, wherein the framework silicate mineral is a Feldspar.

5. A formulation according to claim 4 wherein the framework silicate mineral is a Feldspar with a predominance of NaAlSi₃O₈ and KAlSi₃O₈.

6. A formulation according to claim 4, wherein the framework silicate mineral is a Feldspar with a predominance of KAlSi₃O₈.

7. A formulation according to claim 1, wherein the concentration of the ammonium salt is in the range 1×10⁻⁵ to 10 M.

8. A formulation according to claim 1 which in use causes the water-containing quantity to freeze at a supercooling of 8° C. or less.

9. A formulation according to claim 1 further comprising one or more cryoprotectants.

10. A formulation according to claim 9 wherein the or each cryoprotectant is characterised by the presence of a plurality of hydroxyl groups.

11. A formulation according to claim 1 which is biologically tolerable.

12. A method of use of a formulation comprising freeze processing a water-containing quantity of a biological entity in a vessel containing the formulation of claim 1.

13. The method of claim 12, wherein the biological entity is a cell or aggregate of cells.
